(19) United States
(12) Patent Application Publication
(10) Pub. No.: US 2024/0375521 A1
(43) Pub. Date: Nov. 14, 2024

(54) Adjustable Solar Panel System for Vehicles and Method of Use

(71) Applicant: Thomas Hammond, Comer, GA (US)

(72) Inventor: Thomas Hammond, Comer, GA (US)

(21) Appl. No.: 18/504,252

(22) Filed: Nov. 8, 2023

Related U.S. Application Data
(60) Provisional application No. 63/501,209, filed on May 10, 2023.

(51) Int. Cl. B60L 8/00; H02J 7/35; H02S 20/32

(52) U.S. Cl. CPC B60L 8/003; H02J 7/35; H02S 20/32

(57) ABSTRACT

A solar panel system integrated or retrofitted on the roof of a vehicle for recharging an electric battery of the vehicle by absorbing solar energy and converting it into electric power. The system includes a solar panel pivotally connected to a pair of arms; each arm is designed to slide along the roof rails of the vehicle. The solar panel is adjustable using a hinge disposed for each arm to absorb maximum solar power. The solar panel can be adjusted automatically using a sensor or manually by a user using a control panel. The system can also function as a sunroof and can be integrated into sunroof rails or on customized rails attached to the roof of the vehicle. In one embodiment, the ECU continuously monitors the battery level of the internal battery and enables solar power to recharge the battery when the battery level falls below a specified threshold.

### CROSS-REFERENCE TO RELATED APPLICATION

The present application claims priority to, and the benefit of, U.S. Provisional Application No. 63/501,209, which was filed on May 10, 2023, and is incorporated herein by reference in its entirety.

### FIELD OF THE INVENTION

The present invention generally relates to the field of solar charging systems for electric vehicles. More specifically, the present invention relates to a novel solar panel system that features an adjustable solar panel integrated into the vehicle's structure, capable of absorbing solar energy and converting it into electricity. The solar panel system can be integrated or retrofitted and the solar panel is adjustable either automatically or manually to face the sun for absorbing solar power. The solar panel system can enable people to travel longer distances in their electric vehicles without requiring frequent charging of the battery at charging stations. Accordingly, the present disclosure makes specific reference thereto. Nonetheless, it is to be appreciated that aspects of the present invention are also equally applicable to other like applications, devices, and methods of manufacture.

### BACKGROUND

By way of background, electric vehicles (EVs) have become popular in the last few years as EVs are more environmentally efficient compared to traditional gasoline-powered vehicles. EVs are considered “green” because they produce zero tailpipe emissions and run on electricity, which can be generated from renewable sources like wind, solar, or hydropower, further reducing their carbon footprint. EVs do not cause pollution and are cost-effective while in use as well. With their low operating costs, many drivers opt to purchase electric vehicles as a way to save money on fuel costs. EVs have made significant advancements in terms of their driving range on a single charge. However, despite their advantages and advancements, the inconvenience of charging electric vehicles is still a deterrent for some potential buyers.

One of the biggest challenges faced by electric vehicle owners is the issue of charging their electric vehicles. Also, EV batteries may lose charge relatively quickly, especially in extreme weather conditions (such as extreme cold or heat) or when operating energy-intensive features like air conditioning or rapid acceleration. Owners of EVs suffer from range anxiety which is the uncertainty of an EV's battery running out of charge before reaching the destination or the nearest charging station. Unlike traditional gas stations, which are widespread and easily accessible, EV charging stations are still not as prevalent, particularly in some regions.

Further, the process of charging an electric vehicle can be time-consuming, particularly if the battery is completely depleted. While some public charging stations are available, many drivers find that these stations are not always conveniently located or readily available when they need them. People desire an alternative way for charging their electric vehicle battery which enables people to travel longer distances in their electric vehicles without having to locate a charging station.

Therefore, there exists a long-felt need in the art for a solar charging system for recharging a battery of an electric vehicle. Additionally, there is a long-felt need in the art for a solar panel system that can be integrated or retrofitted in a vehicle and coupled to an internal electric battery of the vehicle. Moreover, there is a long-felt need in the art for a solar panel system that absorbs solar energy and provides electric power to recharge the vehicular battery. Further, there is a long-felt need in the art for a solar panel system that enables the solar panel to adjust to a specific angle to maximize solar energy absorption. Furthermore, there is a long-felt need in the art for a solar panel system to recharge electric vehicles that enables people to travel longer distances in their electric vehicles without having to frequently recharge their vehicles. Finally, there is a long-felt need in the art for an alternative charging system for electric vehicles that offers a sustainable and convenient solution to charging electric vehicles using adjustable solar panels.

The subject matter disclosed and claimed herein, in one embodiment thereof, comprises an adjustable solar panel system designed to be installed on the roof of a vehicle for absorbing solar energy and charging an electric battery of the vehicle. The solar panel system features a solar panel, a pair of adjustable arms, each adjustable arm is positioned between a rear surface of the solar panel and a sunroof rail of the vehicle, a pair of hinges, wherein each hinge is equipped with markings denoting angles ranging from zero degrees to 360 degrees. The adjustable arms slide along channels within rails and the solar panel automatically pivots or adjusts angularly using hinges relative to the adjustable arms to orient the solar panel toward incoming sunlight, thereby optimizing the absorption of solar energy. The solar panel can be adjusted automatically using a sensor or manually using a control panel positioned inside the vehicle.

In this manner, the adjustable solar panel system of the present invention accomplishes all of the foregoing objectives and provides users with a solar panel system integrated into a vehicle roof designed to charge the vehicle's battery while the vehicle is parked or traveling. The solar panel can be adjusted to a specific angle to maximize solar energy absorption. The system enables people to travel longer distances in their electric vehicles without having to locate a charging station, preventing them from being stranded in dangerous or remote areas.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar panel system integrated into the roof of an electric vehicle. The system comprising an adjustable solar panel integrated into the sunroof of the vehicle. The solar panel includes a plurality of photovoltaic cells configured for absorbing solar energy and converting the absorbed solar energy into electrical energy to recharge an electric battery of the vehicle. The adjustable solar panel is installed using a pair of adjustable arms, wherein the adjustable arms are adapted to slide along the rails positioned in the sunroof of the vehicle. Each rail has a corresponding channel along the length thereof, wherein the bottom end of each adjustable arm slides within the corresponding channel to adjust the inclination of the solar panel. A supporting arm is fastened across the rear surface of the solar panel, wherein the top end of the first adjustable arm is connected to one end of the supporting arm, and the top end of the second adjustable arm is connected to the opposite end of the supporting arm. A hinge is positioned at each of the top ends of the adjustable arms wherein the solar panel is adjusted relative to the adjustable arms to absorb the solar energy.

In a further embodiment, an electric vehicle equipped with an adjustable solar panel system is disclosed. The solar panel system includes a solar panel, a pair of arms, and a pair of rails, wherein the rails can be positioned in the sunroof or on the roof of the vehicle, each rail has a channel, a bottom end of each arm slides along the channel, the top end of each arm is pivotally connected to the solar panel using a hinge, wherein the solar panel is angularly adjusted manually or automatically to absorb the solar energy wherein the absorbed solar energy is converted into electrical power for recharging internal battery of the vehicle.

In yet another embodiment, an adjustable solar panel system for absorbing solar energy and charging an electric battery of a vehicle is disclosed. The solar panel system comprising a solar panel, a pair of adjustable arms, wherein each adjustable arm is positioned between a rear surface of the solar panel and a sunroof rail of the vehicle, a pair of hinges, each hinge is equipped with markings denoting angles ranging from zero degrees to 360 degrees. The adjustable arms slide along channels within rails and the solar panel automatically pivots or adjusts angularly relative to the adjustable arms to orient the solar panel toward incoming sunlight, thereby optimizing the absorption of solar energy.

In still a further embodiment, a solar panel system installed on the roof of a vehicle is disclosed. The system comprising a pair of rails, each rail has a channel along the length thereof, a solar panel pivotally connected to a pair of parallel arms, each arm having a top end and a bottom end, the bottom end of each arm slides along the channel of a corresponding rail, the top end is fixed along an edge of the solar panel, a hinge is positioned at the junction of the top end of each arm and the solar panel, wherein the solar panel angularly adjusts relative to the arms to absorb the solar energy by orienting towards the solar light.

In a further embodiment, a solar panel integration and power management system for a vehicle is disclosed. The system comprising an adjustable solar panel integrated into the vehicle, and an Electronic Control Unit (ECU) internally connected to the solar panel for regulating and monitoring electric power received from the solar panel, the ECU monitors the battery level status of an internal battery within the vehicle and determines the need for battery charging. The ECU permits the flow of electric power from the solar panel when the battery level is less than 90% of the total battery level of the internal battery.

Numerous benefits and advantages of this invention will become apparent to those skilled in the art to which it pertains upon reading and understanding the following detailed specifications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a solar panel integrated vehicle of the present invention in accordance with the disclosed structure;

FIG. 2 illustrates a perspective view of the solar panel system of the present invention in accordance with the disclosed structure;

FIG. 3 illustrates an enlarged view of the hinge and connection of the first arm and the supporting arm used for pivoting movement of the solar panel in accordance with the disclosed structure;

FIG. 4 illustrates a functional block diagram depicting the connection of the solar panel with the internal battery of the vehicle for recharging the battery in accordance with the disclosed architecture;

FIG. 5 illustrates a control panel installed on the dashboard of the vehicle for enabling a passenger of the vehicle to angularly adjust the solar panel installed on the vehicle in accordance with the disclosed structure; and

FIG. 6 illustrates a perspective view of another embodiment of the solar charging system used with a vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a solar charging system for recharging a battery of an electric vehicle. Additionally, there is a long-felt need in the art for a solar panel system that can be integrated or retrofitted in a vehicle and coupled to an internal electric battery of the vehicle. Moreover, there is a long-felt need in the art for a solar panel system that absorbs solar energy and provides electric power to recharge the vehicular battery. Further, there is a long-felt need in the art for a solar panel system that enables the solar panel to adjust to a specific angle to maximize solar energy absorption. Furthermore, there is a long-felt need in the art for a solar panel system to recharge electric vehicles that enables people to travel longer distances in their electric vehicles without having to frequently recharge their vehicles. Finally, there is a long-felt need in the art for an alternative charging system for electric vehicles that offers a sustainable and convenient solution to charging electric vehicles using adjustable solar panels.

The present invention, in one exemplary embodiment, is a solar panel system installed on the roof of a vehicle. The system comprising a pair of rails, each rail has a channel along the length thereof, a solar panel pivotally connected to a pair of parallel arms, wherein each arm having a top end and a bottom end, the bottom end of each arm slides along the channel of a corresponding rail, the top end is fixed along an edge of the solar panel, a hinge is positioned at the junction of the top end of each arm and the solar panel, wherein the solar panel angularly adjusts relative to the arms to absorb the solar energy by orienting towards the solar light.

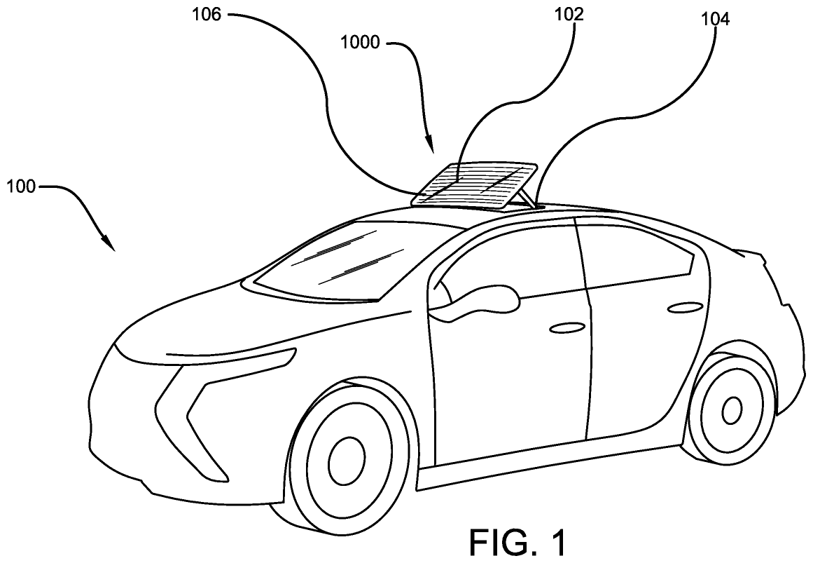

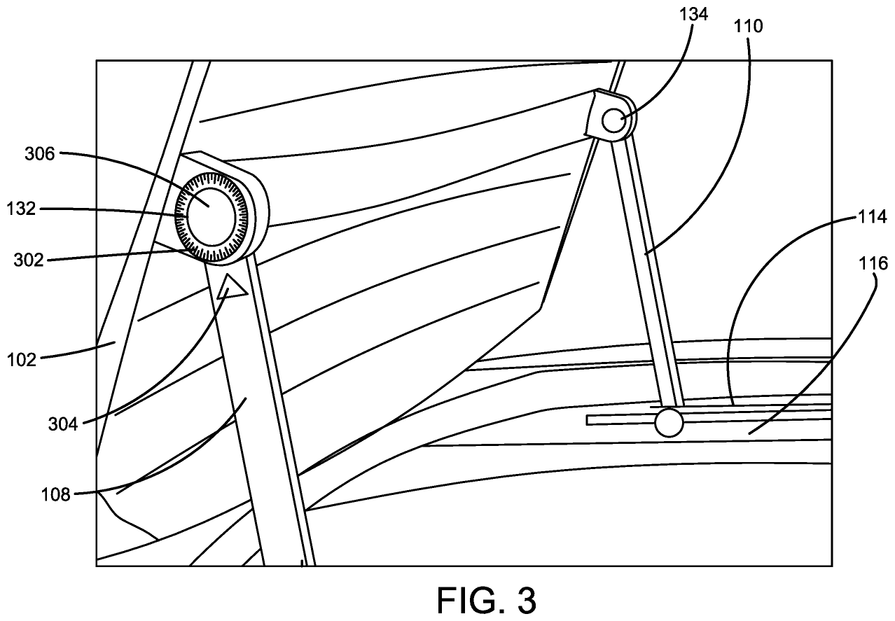

Referring initially to the drawings, FIG. 1 illustrates a perspective view of a solar panel integrated vehicle of the present invention in accordance with the disclosed structure. The solar panel integrated vehicle 100 is a specially designed vehicle such as an electric vehicle having an integrated solar panel system 1000. The solar panel charging system 1000 includes an adjustable solar panel 102 integrated into the sunroof 104 of the electric vehicle 100. The solar panel 102 includes a plurality of photovoltaic cells 106 configured for absorbing solar energy and converting the absorbed solar energy into electrical energy to recharge the electric battery of the vehicle 100 as illustrated in FIG. 3.

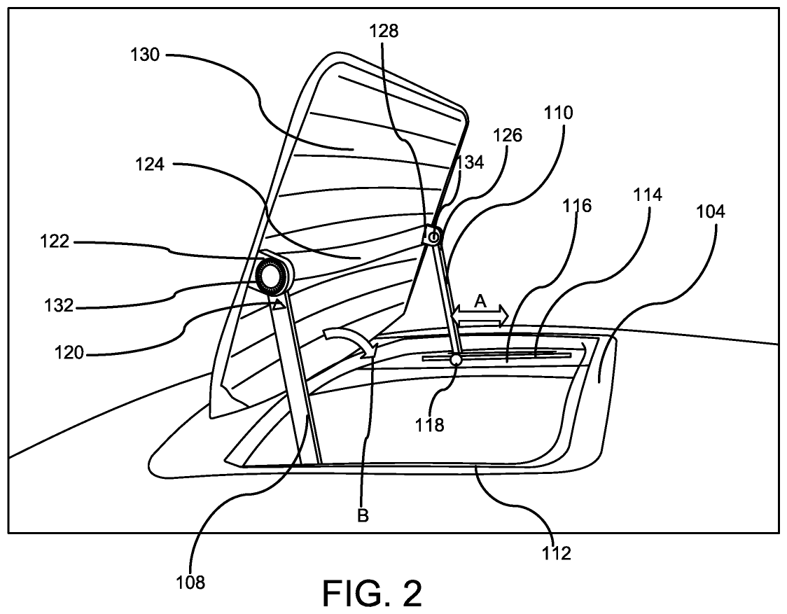

Referring to FIGS. 1 and 2, the solar panel 102 is installed using a pair of adjustable arms 108, 110. The arms 108, 110 are adapted to slide (Arrow A, FIG. 2) along the corresponding rails 112, 114 positioned in the sunroof 104. More specifically, each rail 112, 114 has a corresponding channel 116 along the length of the rail through which the bottom end 118 of the arm slides to adjust the inclination of the solar panel 102. The top end 120 of the first arm 108 is connected to one end 122 of the supporting arm 124 and the top end 126 of the second arm 110 is connected to the opposite end 128 of the supporting arm 124. The supporting arm 124 is fastened across the rear surface 130 of the solar panel 102 where the top ends 120, 126 are connected using pivoting hinges 132, 134, respectively.

In the present embodiment, the solar panel 102 is dimensioned to cover the sunroof 104 of the vehicle 100 to also function as a sunroof cover when the solar panel 102 is not in an inclined position to absorb solar power. The solar panel 102 is pivotally movable (Arrow B, FIG. 2) along the hinges 132, 134 to move from a first position which is substantially perpendicular to the rails 112, 114 to a second position which is substantially parallel to the sunroof 104 to cover the sunroof 104. The solar panel 102 is designed to absorb solar energy to convert it into electrical power during all times even when the vehicle 100 is not running.

In some embodiments, the solar panel 102 can change color thereof when the sunlight does not impinge on the solar panel 102 for functioning as a conventional sunroof cover. Also, the solar panel system 1000 is waterproof, rugged, and durable and can withstand weather elements such as rain, snow, and more. Further, the solar panel 102 and the arms 108, 110 can be designed to be integrated into sunroofs of different shapes and sizes included in different vehicles.

FIG. 3 illustrates an enlarged view of the hinge and connection of the first arm and the supporting arm used for the pivoting movement of the solar panel in accordance with the disclosed structure. The hinges 132, 134 are designed to be turned in both clockwise and counterclockwise directions to enable pivotal movement of the solar panel 102. As illustrated, the hinge 132 has markings 302 ranging from zero degrees to 360 degrees and an indication mark 304 in the form of an arrow. The indication mark 304 points to the angle at which the solar panel 102 is inclined relative to the arms 108, 110. As the arms 108, 110 slide along the channels 116 of the rails 112, 114, the solar panel 102 automatically pivots or angularly adjusts relative to the arms 108, 110 for enabling positioning of the solar panel 102 towards the sun rays to absorb maximum solar energy.

In some embodiments, the hinges 132, 134 have built-in power sensors 306 for measuring solar energy impinging on the solar panel 102 and to automatically position the solar panel 102 for absorbing the maximum solar energy.

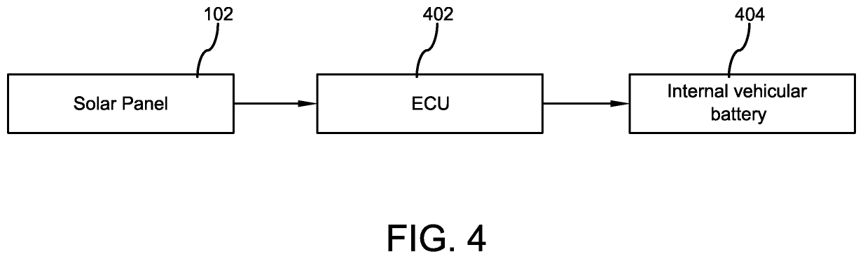

FIG. 4 illustrates a functional block diagram depicting the connection of the solar panel with the internal battery of the vehicle 100 for recharging the battery in accordance with the disclosed architecture. The solar panel 102 is internally connected to an Electronic Control Unit (ECU) 402 of the vehicle 100 for regulating and monitoring electric power received from the solar panel 102. In the preferred embodiment, the ECU 402 monitors the battery level status of the internal battery 404 and determines if the charging is required for the battery 404. When it is determined that the battery 404 requires charging, the ECU 402 enables the electricity from the solar panel 102 to flow into the battery 404. In some embodiments, the ECU 402 enables electric power to flow when the battery level is less than 90% of the total battery level of the internal battery 404. In some of the vehicles, where more than one electric battery is installed, the solar panel 102 can be coupled to one or all of the batteries of the electric vehicle for providing electric power.

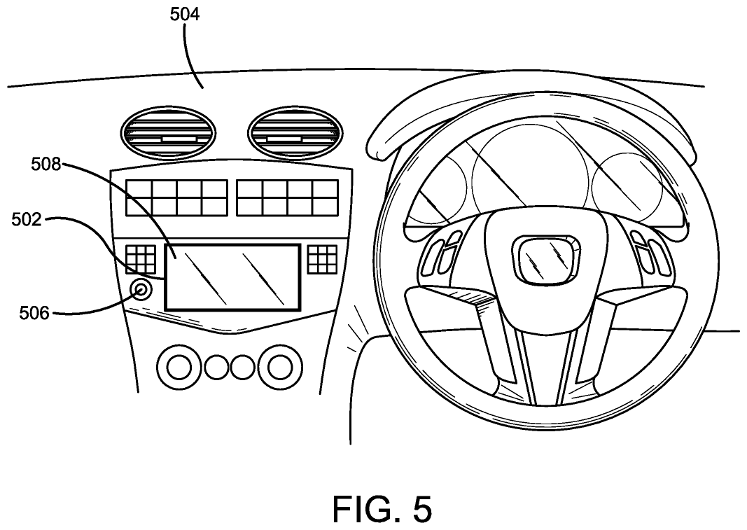

FIG. 5 illustrates a control panel installed on the dashboard of the vehicle 100 for enabling a passenger of the vehicle to angularly adjust the solar panel installed on the vehicle in accordance with the disclosed structure. In the present embodiment, for manually adjusting the inclination of the solar panel 102 to orient toward the sunlight, a control panel 502 is provided in the dashboard 504 of the vehicle 100. The control panel 502 includes a control knob 506 to adjust the inclination of the panel 102 and a display module 508 to show the position or angle of the solar panel 102. The display module 508 displays the real-time position of the solar panel 102 and helps a user in adjusting the position of the solar panel 102. The control panel 502 can be integrated during manufacturing of the vehicle 100 or can alternatively be installed as an aftermarket product. The display module 508 can also display an augmented reality display of the position of the solar panel for review by a user.

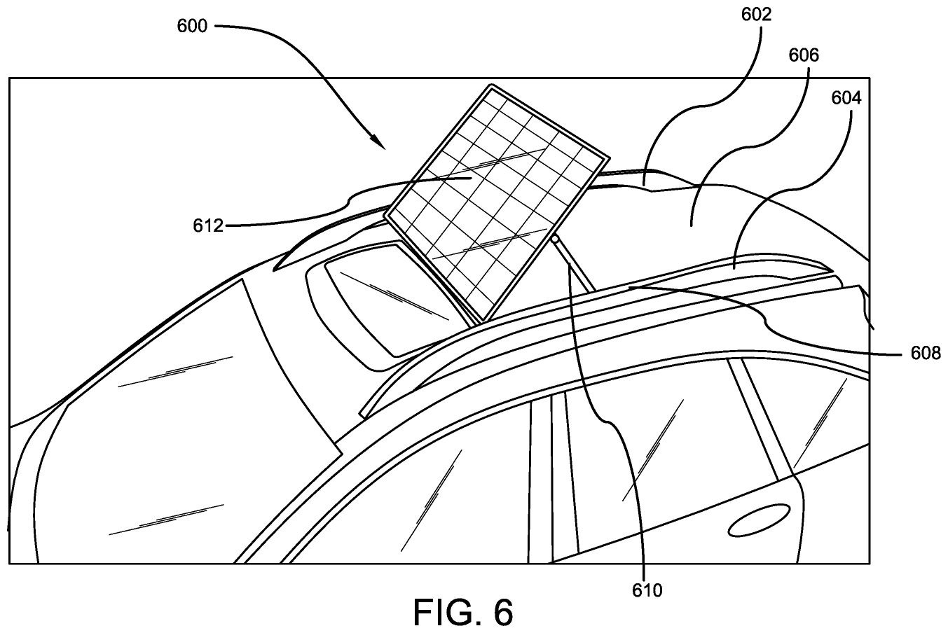

FIG. 6 illustrates a perspective view of another embodiment of the solar charging system used with a vehicle in accordance with the disclosed architecture. In the present invention, the electric vehicle solar charging system 600 is installed on the vehicle as an aftermarket product and therefore can be used with existing vehicles. A pair of roof rails 602, 604 are installed on the roof 606 of the vehicle and each rail has a channel 608 (similar to the channel 116 of FIG. 2). The channels 608 extends along the length of the rails 602, 604, and provides a sliding means for the arms 610. It will be apparent to a person skilled in the art that only one arm 610 is shown in FIG. 6 but an opposite and symmetrical arm, similar to FIG. 2, is provided for the rail 604.

The solar panel 612 is angularly coupled to the arms 610 and adjusts in inclination along with sliding along the rails 602, 604 using the arms 610. The solar panel 612 can be manually or automatically adjusted like other embodiments for absorbing maximum solar energy to recharge the internal vehicular battery. The rails 602, 604 are installed on the roof like conventional roof rails and the solar panel 612 is detachably attached to the roof rails. Further, the roof rails 602, 604 and the solar panel 612 can be of different sizes to be installed on different vehicles.

The solar panels used in different embodiments of the present invention coupled to the internal battery enable simultaneous charging of the vehicle's battery while the vehicle is in use thereby reducing the need for drivers to return home or find a charging station frequently. Also, the solar panels can be mounted in a roof rail, wherein the rail can be added to existing vehicles or incorporated during the manufacturing process. The solar panel system 1000, 600 can be removed from one vehicle and can be retrofitted to another vehicle as per the requirements of users. It is believes that the present invention will be particularly useful on vans and buses, especially school buses, as these vehicles have enough roof area to accept multiple panels.

In some embodiments, an artificial intelligence system is integrated with the solar panel and is configured to continuously analyze data from various sensors, weather forecasts, and traffic conditions to predict energy needs and optimize energy usage. The AI module can also dynamically adjust the solar panel angle and even vehicle speed to maximize energy efficiency in autonomous vehicles. The solar panels can be made of silicon cells and can also be made of perovskite solar cells.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar panel integrated vehicle”, “electric vehicle”, and “vehicle” are interchangeable and refer to the solar panel integrated electric vehicle 100 of the present invention. Similarly, as used herein “solar panel charging system”, “solar panel system”, and “electric vehicle solar charging system” are interchangeable and refer to the electric vehicle solar panel system 1000, 600 of the present invention.

Notwithstanding the foregoing, the solar panel integrated electric vehicle 100 and the electric vehicle solar panel system 1000, 600 of the present invention can be of any suitable size and configuration as is known in the art without affecting the overall concept of the invention, provided that they accomplish the above-stated objectives. One of ordinary skill in the art will appreciate that the solar panel integrated electric vehicle 100 and the electric vehicle solar panel system 1000, 600 as shown in the FIGS. 1-3 and 5-6 are for illustrative purposes only, and that many other sizes and shapes of the solar panel integrated electric vehicle 100 and the electric vehicle solar panel system 1000, 600 are well within the scope of the present disclosure. Although the dimensions of the solar panel integrated electric vehicle 100 and the electric vehicle solar panel system 1000, 600 are important design parameters for user convenience, the solar panel integrated electric vehicle 100 and the electric vehicle solar panel system 1000, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle solar panel charging system comprising:
an adjustable solar panel integrated into a sunroof of an electric vehicle including a pair of adjustable arms and a pair of corresponding rails positioned in said sunroof;
wherein said adjustable arms slidable along said corresponding rails;
wherein each said adjustable rail having a corresponding channel along a length of said adjustable rail for selective sliding of each said adjustable rail;
wherein said pair of adjustable arms having a first arm including a first top end connected to a first end of a supporting arm and a second arm including a second top end connected to a second end of said supporting arm;
wherein said supporting arm fastened across a rear surface of said vehicular solar panel; and
further wherein said supporting arm, including said first top end and said second top end, having a pair of pivoting hinges for adjusting an inclination of said vehicular solar panel.

2. The vehicle solar panel charging system of claim 1, wherein said solar panel having a plurality of photovoltaic cells for absorbing solar energy and converting said absorbed solar energy into electrical energy.

3. The vehicular solar panel charging system of claim 2, wherein said electrical energy for recharging an electric battery of the electric vehicle.

4. The vehicular solar panel charging system of claim 3, wherein said vehicular solar panel having dimensions equal to dimensions of said sunroof.

5. The vehicular solar panel charging system of claim 4, wherein said vehicular solar panel pivotally movable from a first position perpendicular to said rails to a second position parallel to said rails.

6. The vehicular solar panel charging system of claim 5, wherein each of said pair of pivoting hinges rotatable in both clockwise and counterclockwise directions.

7. The vehicular solar panel charging system of claim 6, wherein at least one of said pair of pivoting hinges having inclination markings ranging from zero degrees to 360 degrees and an indication marker indicating said inclination of said vehicular solar panel.

8. A vehicle solar panel charging system comprising:
an adjustable solar panel integrated into a sunroof of an electric vehicle including a pair of adjustable arms and a pair of corresponding rails positioned in said sunroof;
wherein said adjustable arms slidable along said corresponding rails;
wherein each said adjustable rail having a corresponding channel along a length of said adjustable rail for selective sliding of each said adjustable rail;
wherein said pair of adjustable arms having a first arm including a first top end connected to a first end of a supporting arm and a second arm including a second top end connected to a second end of said supporting arm;
wherein said supporting arm fastened across a rear surface of said vehicular solar panel;
wherein said supporting arm, including said first top end and said second top end, having a pair of pivoting hinges for adjusting an inclination of said vehicular solar panel;
wherein each of said pair of pivoting hinges rotatable in both clockwise and counterclockwise directions; and
further wherein at least one of said pair of pivoting hinges having inclination markings ranging from zero degrees to 360 degrees and an indication marker indicating said inclination of said vehicular solar panel.

9. The vehicle solar panel charging system of claim 8, wherein said solar panel having a plurality of photovoltaic cells for absorbing solar energy and converting said absorbed solar energy into electrical energy.

10. The vehicular solar panel charging system of claim 9, wherein said electrical energy for recharging an electric battery of the electric vehicle.

11. The vehicular solar panel charging system of claim 10, wherein said vehicular solar panel having dimensions equal to dimensions of said sunroof.

12. The vehicular solar panel charging system of claim 11, wherein said vehicular solar panel pivotally movable from a first position perpendicular to said rails to a second position parallel to said rails.

13. A vehicle solar panel charging system comprising:
an adjustable solar panel integrated into a sunroof of an electric vehicle including a pair of adjustable arms and a pair of corresponding rails positioned in said sunroof;
wherein said adjustable arms slidable along said corresponding rails;
wherein each said adjustable rail having a corresponding channel along a length of said adjustable rail for selective sliding of each said adjustable rail;
wherein said pair of adjustable arms having a first arm including a first top end connected to a first end of a supporting arm and a second arm including a second top end connected to a second end of said supporting arm;
wherein said supporting arm fastened across a rear surface of said vehicular solar panel;
wherein said supporting arm, including said first top end and said second top end, having a pair of pivoting hinges for adjusting an inclination of said vehicular solar panel;
wherein each of said pair of pivoting hinges rotatable in both clockwise and counterclockwise directions;
wherein at least one of said pair of pivoting hinges having inclination markings ranging from zero degrees to 360 degrees and an indication marker indicating said inclination of said vehicular solar panel; and
further wherein at least one of said pair of pivoting hinges having a built-in power sensor for measuring solar energy impinging on said vehicular solar panel and autonomously positions said vehicular solar panel for absorbing the maximum solar energy.

14. The vehicular solar panel charging system of claim 13, wherein said vehicular solar panel connected to an internal battery of the vehicle for recharging the internal battery of the vehicle.

15. The vehicular solar panel charging system of claim 14, wherein said vehicular solar panel connected to an ECU of the vehicle for regulating and monitoring electric energy received from said vehicular solar panel.

16. The vehicular solar panel charging system of claim 15, wherein said ECU monitors a battery level status of the internal battery of the vehicle and flows said electric energy from said vehicular solar panel to the internal battery of the vehicle.

17. The vehicular solar panel charging system of claim 16, wherein said electric energy flows from said vehicular solar panel when the internal battery level is less than 90% of the total battery level of the internal battery of the vehicle.

18. The vehicle solar panel charging system of claim 17, wherein said solar panel having a plurality of photovoltaic cells for absorbing solar energy and converting said absorbed solar energy into said electric energy.

19. The vehicular solar panel charging system of claim 18, wherein said vehicular solar panel having dimensions equal to dimensions of said sunroof.

20. The vehicular solar panel charging system of claim 19, wherein said vehicular solar panel pivotally movable from a first position perpendicular to said rails to a second position parallel to said rails.
